(19) United States
(12) Patent Application Publication
(10) Pub. No.: US 2025/0298180 A1
(43) Pub. Date: Sep. 25, 2025

(54) FIXATING A LIGHT GUIDE WITHOUT COMPROMISING THE OPTICAL FUNCTION

(71) Applicant: SIGNIFY HOLDING B.V., EINDHOVEN (NL)

(72) Inventors: DERK TIEKINK, MIERLO (NL); PETER JOHANNES MARTINUS BUKKEMS, DEURNE (NL); BARRY MOS, LIMBURG (BE); MARCUS THEODORUS MARIA LAMBOOIJ; RENÉ BELTMAN, VUGHT (NL)

(21) Appl. No.: 18/863,543

(22) PCT Filed: May 10, 2023
(86) PCT No.: PCT/EP2023/062369

§ 371 Date: Nov. 6, 2024

(30) Foreign Application Priority Data
May 12, 2022 (EP) 22172897.5

(51) Int. Cl. F21V 8/00

(52) U.S. Cl. CPC G02B 6/0088; G02B 6/0046; G02B 6/0068; G02B 6/009

(57) ABSTRACT

The invention provides a light generating system (1000) comprising (i) a one or more light generating devices (100) configured to generate device light (101), (ii) a lightguide body arrangement (240) comprising a lightguide body (250), and (iii) a support system (400); wherein: —the lightguide body (250) comprises (a) a first face (251) and a second face (252), which define a width (W) of the lightguide body (250), (b) a first end (261) and a second end (262), which define a height (H) of the lightguide body (250), wherein the lightguide body (250) comprises a support structure (270) protruding from the first face (251) or recessed relative to the first face (251); wherein the first end (261) is configured in a light-receiving relationship with the one or more light generating devices (100); and wherein the lightguide body (250) is transmissive for the device light (101); wherein the lightguide body tapers over a part of the height (H) in a direction from the first end to the second end; wherein the light guide body comprises a first taper end point at the first face and a second taper end point at the second face, wherein said first taper end point and said second taper end point demarcate the point at which said light guide body stops tapering in the direction from the first end to the second end; wherein the lightguide body comprises an expanded end part element; and—the support system (400) comprises (a) a device support part (410) and (b) a lightguide body support part (420); wherein the device support part (410) is configured to support the one or more light generating devices (100); wherein the lightguide body support part (420) comprises one or more support elements (421); wherein a first support element (1421) of the one or more support elements (421) is configured in physical contact with the support structure (270) at an arrangement support position (241) at a distance d from the first end (261), wherein 0≤(d/H)<1; and wherein the first support element (1421) and the support structure (270) are configured to fixate the lightguide body (250) relative to the support system (400) in a direction parallel to the height (H).

### FIELD OF THE INVENTION

The invention relates to a light generating system comprising one or more light generating devices. The invention further relates to a lighting device comprising such light generating system and to a method for assembling such light generating system. The invention further relates to a lightguide body for use in such a light generating system.

### BACKGROUND OF THE INVENTION

Modules comprising light guide plates are known in the art. For instance, US2008036942A1 describes a backlight module including a fame having a plurality of side walls; a light guide plate received in the frame, having a light incident surface; at least one spring element, having a spring finger and a connecting arm connecting the spring finger and one side wall of the frame; and at least one radiation element disposed between the spring finger and the light incident surface. The width of the at least one radiation element is larger than a distance between the light incident surface and the spring finger in a free state.

### SUMMARY OF THE INVENTION

A light generating system may contain a fixed lightguide body arrangement, where the arrangement contains a lightguide body and a device support system configured to support light generating devices and the lightguide body. In particular, the lightguide body may be held in position and aligned with the light generating devices by mechanical fixation. However, this may influence the optical performance of the lightguide body or result in sagging over time due to thermal and aging effects.

Hence, it is an aspect of the invention to provide an alternate support system for the lightguide body which preferably further at least partly obviates one or more of above-described drawbacks. The present invention may have as object to overcome or ameliorate at least one of the disadvantages of the prior art, or to provide a useful alternative.

The invention is set out in the appended set of independent claims and depended claims.

Hence, in a first aspect, the invention provides a light generating system comprising one or more light generating devices configured to generate device light, and a lightguide body arrangement. This lightguide body arrangement may comprise a lightguide body and a support system. The lightguide body may comprise a first face and a second face, which may define a width (W) of the lightguide body. Further, the lightguide body may comprise a first end and a second end which may define a height (H) of the lightguide body. In particular, the lightguide body may comprise a support structure protruded or recessed relative to the first face. Especially, the first end may be configured in a light-receiving relationship with one or more light generating devices. Especially, the lightguide may be transmissive for the device light.

In embodiments, the support system may comprise a device support part and a lightguide body support part. The device support part may be configured to support one or more light generating devices. In embodiments, the lightguide body support part comprises one or more support elements, wherein a first support element of the support elements is configured in physical contact with the support structure at an arrangement support position at a distance d from the first end. The first support element and the support structure may especially be configured to fixate the lightguide body relative to the support system in a direction parallel to the height (H). Therefore, in embodiments the invention provides a light generating system comprising (i) a one or more light generating devices configured to generate device light, (ii) a lightguide body arrangement comprising a lightguide body, and (iii) a support system; wherein: (A) the lightguide body comprises (a) a first face and a second face, which define a width (W) of the lightguide body, (b) a first end and a second end, which define a height (H) of the lightguide body, wherein the lightguide body comprises a support structure protruding from the first face or recessed relative to the first face; wherein the first end is configured in a light-receiving relationship with the one or more light generating devices; and wherein the lightguide body is transmissive for the device light; wherein the lightguide body tapers over a part of the height (H) in a direction from the first end to the second end; wherein the light guide body comprises a first taper end point at the first face and a second taper end point at the second face, wherein said first taper end point and said second taper end point demarcate the point at which said light guide body stops tapering in the direction from the first end to the second end; wherein the lightguide body comprises an expanded end part element; and (B) the support system comprises (a) a device support part and (b) a lightguide body support part; wherein the device support part is configured to support the one or more light generating devices; wherein the lightguide body support part comprises one or more support elements; wherein a first support element of the one or more support elements is configured in physical contact with the support structure at an arrangement support position at a distance d from the first end, wherein 0≤(d/H)<1; and wherein the first support element and the support structure are configured to fixate the lightguide body relative to the support system in a direction parallel to the height (H).

Throughout the application, said support structure protruded or recessed relative to the first face may be phrased as said support structure protruding from the first face or recessed relative to the first face. Hence, the support structure may be on the first face and protruding from the first face.

The invention may provide the benefit that the support structure facilitates fixating the lightguide body substantially without influencing the optical performance of the lightguide body or resulting in sagging over time due to thermal and aging effects. Hence, in the present invention, the lightguide body may be fixated by a support system allowing light to be transmitted through the lightguide body and escape from the second face and the second end. The support system may especially be configurated such that it has minimal influence on the optical performance of the light generating system by not covering substantial parts of the second face. Further, the support system may be configurated to be supported with an expanded end part which allows light to escape from the second end while providing additional support that does not lead to sagging from thermal and aging effects. Yet further, the invention may facilitate ease of assembly as the assembly and fixation of its components may be relatively straightforward.

Hence, the invention provides a lightguide body, wherein the lightguide body comprises (a) a first face and a second face, which define a width (W) of the lightguide body, (b) a first end and a second end, which define a height (H) of the lightguide body, wherein the lightguide body comprises a support structure protruded or recessed relative to the first face; wherein the first end is configured to be in a light-receiving relationship with the one or more light generating devices emitting device light; and wherein the lightguide body is transmissive for the device light; wherein the lightguide body tapers over a part of the height (H) in a direction from the first end to the second end; wherein the light guide body comprises a first taper end point at the first face and a second taper end point at the second face, wherein said first taper end point and said second taper end point demarcate the point at which said light guide body stops tapering in the direction from the first end to the second end. Furthermore, the lightguide body comprises an expanded end part element, wherein the expanded end part element comprises (a) a flat face abutting the first face at the first taper end point, wherein the flat face is arranged at an angle between 20 and 50 degrees relative to the first face, and (b) a (at least partly) curved face abutting the second face at the second taper end point and comprising a curvature; wherein the flat face and the curved face connect (or: abut, or: intersect) to each other. Thereby, advantages and/or embodiments applying to the lightguide body arrangement AND/OR the light generating system according to the initial aspect of the invention may mutatis mutandis apply to this further aspect according to the invention

Said angle is defined between the flat face and a plane defined by the first face. Said flat face extends from the first taper point onwards in a direction away from the second face (when under said angle). Said curvature may e.g. be at least partly circular, or elliptical. Said first taper end point and said second taper endpoint may alternatively be phrased as first taper line and second taper line, which demarcate the respective line at which said light guide body stops tapering in the direction from the first end to the second end. This phrasing may be more suitable when the lightguide body is defined having a length (L). Said curved face may alternatively be defined as an at least partly curved face, for example, the at least partly curved face may comprise at least one curved part and at least one straight part, but therefore still be at least partly curved.

The lightguide body according to the invention may be used in the light generating system according to the invention, or be part of the lightguide body arrangement according to the invention.

In an embodiment, (a) the lightguide body tapers over a part of the height (H) in the direction from the first end to the second end with a tapering angle (a) selected from the range of 0.5-5°, and (b) the lightguide body comprises outcoupling elements configured to facilitate outcoupling of the device light via the second face.

The advantage of said lightguide body according to the second aspect of the invention is that the expanded end part element reduces glare, which originates from the fact that the optical performance of the lightguide body (that is advantagously fixated with the support structure) is improved (i.e. allowing light to be transmitted through optimally with for example an support system that has minimal influence thereto).

Moreover, said expanded end part renders a small extension of the lightguide body that concentrates light in the vertical direction, spreads the light across a larger surface, and creates a significantly more uniform spatial luminance under all relevant viewing angles, which is beneficial for a lightguide body (arrangement) that is vertically fixated as part of a light generating system (as in the present application).

In an embodiment, the flat face is preferably arranged at an angle between 35 and 50 degrees relative to the first face. Hence, said angle may most preferably be at least 35 degrees. Said angle may for example be at most 45 degrees. The expanded end part element may therefore spread light across a larger surface at the second end of the lightguide body, because the curved face becomes longer in curvature (as the flat face is curved backwards with a larger angle). This reduces the brightness at the expended end part element and the second end of the lightguide body, thereby reducing glare (which would be a problem without the expended end part element as embodied in said yet further aspect of the invention). Besides that, the expanded end part element can redirect the light towards a vertical downward direction (i.e. downward as defined by the direction from the first end to the second end), which helps to illuminate for example desks below a light generating system comprising said lightguide body, as well as reduce glare for people sitting or walking in an office space around said desks.

In an embodiment, the shortest distance between the first taper end and the second taper end may be at most 6 millimeter, preferably at most 4 millimeter, for example 3 millimeter. This allows a more miniaturized and compact lightguide body, that reduces glare, and is still possible to manufacture with extrusion.

In an embodiment, the lightguide body may comprise a concentration of volume scattering particles. Said volume scattering particles are suitable for rendering forward scattering behaviour in the lightguide body. The volume scattering particles may for example have a diameter which is larger than the wavelength of the incoupled light, i.e., the particle diameter are preferably bigger than 450-650 nm, or more preferred, bigger than 800 nm. Said volume scattering particles may for example be one of: silicon dioxide, polyethylene (PE), silicones, highly chlorinated polyethylene (HCPE), glass. Said volume scattering particles may comprise indices of refractions between 1.42 and 1.52. Said concentration may be a particle volume fraction between 0.1% and 0.4% (relative to the bulk material of the lightguide body), most preferably 0.15% particle volume fraction, for example when the lightguide body comprises the material PMMA (as bulk material). The preferred index of refraction of the volume scattering particles is preferably close to that of the substrate material. This may provide a desired forward scattering behaviour of the lightguide body, and render a downward directed light when fixated vertically (i.e. downward as defined by the direction from the first end to the second end).

In an embodiment, the first taper end point is closer to the first end compared to the second taper end point (i.e. e.g. when measured in the height (H) direction of the lightguide body). In an embodiment, the first taper end point and the second taper end point are located at a distance from the first end point equating to at least 90% of the height (H) of the lightguide body, preferably at least 95%. Hence, the expanded end part element is located at the end of the lightguide body, opposite to the side at which the light is coupled in.

As indicated above, the light generating system may comprise one or more light generating devices configured to generate device light, a lightguide body arrangement comprising a lightguide body, a support system. In other embodiments, the lightguide body arrangement may further comprise additional components, i.e., a reflector element. In further embodiments, the light generating system is configured to generate system light which comprises device light first produced from light generating devices, and then transmitted through the lightguide body and finally escaped from the lightguide body, such as in embodiments via the second face and/or the second end of the lightguide body.

The light generating system may comprise one or more light generating devices, especially a plurality of light generating devices. When the lightguide has a length (L), the light generating system may comprise e.g. at least one light generating devices per 5 cm, such as at least one light generating device per 2 cm (of its a length (L)). In embodiments, the light generating system may comprise at least 10 light generating devices, but the number may be much higher, like at least 100. In embodiments, the light generating system may comprise in the range of 10-1000 light generating devices.

A light generating device may especially be configured to generate device light. Especially, the light generating device may comprise a light source, in specific embodiments preferably solid state light sources. The term “solid state light source”, or “solid state material light source”, and similar terms, may especially refer to semiconductor light sources, such as a light emitting diode (LED), a diode laser, or a superluminescent diode. The light source may especially be configured to generate light source light. In embodiments, the device light may essentially consist of the device light. In other embodiments, the device light may essentially consist of converted light source light. In yet other embodiments, the device light may comprise (unconverted) light source light and converted light source light. Light source light may be converted with a luminescent material into luminescent material light and/or with an upconverter into upconverted light (see also below). The term “light generating device” may also refer to a plurality of light generating devices which may provide device light having essentially the same spectral power distributions. In specific embodiments, the term “light generating device” may also refer to a plurality of light generating devices which may provide device light having different spectral power distributions.

The term “light source” may in principle relate to any light source known in the art. It may be a conventional (tungsten) light bulb, a low pressure mercury lamp, a high pressure mercury lamp, a fluorescent lamp, a LED (light emissive diode). In a specific embodiment, the light source comprises a solid state LED light source (such as a LED or laser diode (or “diode laser”)). The term “light source” may also relate to a plurality of light sources, such as 2-200 (solid state) LED light sources. Hence, the term LED may also refer to a plurality of LEDs. Further, the term “light source” may in embodiments also refer to a so-called chips-on-board (COB) light source. The term “COB” especially refers to LED chips in the form of a semiconductor chip that is neither encased nor connected but directly mounted onto a substrate, such as a PCB. Hence, a plurality of light emitting semiconductor light source may be configured on the same substrate. In embodiments, a COB is a multi LED chip configured together as a single lighting module.

The light source may have a light escape surface. Referring to conventional light sources such as light bulbs or fluorescent lamps, it may be outer surface of the glass or quartz envelope. For LED's it may for instance be the LED die, or when a resin is applied to the LED die, the outer surface of the resin. In principle, it may also be the terminal end of a fiber. The term escape surface especially relates to that part of the light source, where the light actually leaves or escapes from the light source. The light source is configured to provide a beam of light. This beam of light (thus) escapes from the light exit surface of the light source.

Likewise, a light generating device may comprise a light escape surface, such as an end window. Further, likewise a light generating system may comprise a light escape surface, such as an end window.

The term “light source” may refer to a semiconductor light-emitting device, such as a light emitting diode (LEDs), a resonant cavity light emitting diode (RCLED), a vertical cavity laser diode (VCSELs), an edge emitting laser, etc., The term “light source” may also refer to an organic light-emitting diode (OLED), such as a passive-matrix (PMOLED) or an active-matrix (AMOLED). In a specific embodiment, the light source comprises a solid-state light source (such as a LED or laser diode). In an embodiment, the light source comprises a LED (light emitting diode). The terms “light source” or “solid state light source” may also refer to a superluminescent diode (SLED).

The term LED may also refer to a plurality of LEDs.

The term “light source” may also relate to a plurality of (essentially identical (or different)) light sources, such as 2-2000 solid state light sources. In embodiments, the light source may comprise one or more micro-optical elements (array of micro lenses) downstream of a single solid-state light source, such as a LED, or downstream of a plurality of solid-state light sources (i.e. e.g. shared by multiple LEDs). In embodiments, the light source may comprise a LED with on-chip optics. In embodiments, the light source comprises a pixelated single LEDs (with or without optics) (offering in embodiments on-chip beam steering).

In embodiments, the light source may be configured to provide primary radiation, which is used as such, such as e.g. a blue light source, like a blue LED, or a green light source, such as a green LED, and a red light source, such as a red LED. Such LEDs, which may not comprise a luminescent material (“phosphor”) may be indicated as direct color LEDs.

In other embodiments, however, the light source may be configured to provide primary radiation and part of the primary radiation is converted into secondary radiation. Secondary radiation may be based on conversion by a luminescent material. The secondary radiation may therefore also be indicated as luminescent material radiation. The luminescent material may in embodiments be comprised by the light source, such as a LED with a luminescent material layer or dome comprising luminescent material. Such LEDs may be indicated as phosphor converted LEDs or PC LEDs (phosphor converted LEDs). In other embodiments, the luminescent material may be configured at some distance (“remote”) from the light source, such as a LED with a luminescent material layer not in physical contact with a die of the LED. Hence, in specific embodiments the light source may be a light source that during operation emits at least light at wavelength selected from the range of 380-470 nm. However, other wavelengths may also be possible. This light may partially be used by the luminescent material.

In embodiments, the light generating device may comprise a luminescent material. In embodiments, the light generating device may comprise a PC LED. In other embodiments, the light generating device may comprise a direct LED (i.e. no phosphor). In embodiments, the light generating device may comprise a laser device, like a laser diode. In embodiments, the light generating device may comprise a superluminescent diode. Hence, in specific embodiments, the light source may be selected from the group of laser diodes and superluminescent diodes. In other embodiments, the light source may comprise an LED.

The light source may especially be configured to generate light source light having an optical axis (O), (a beam shape,) and a spectral power distribution. The light source light may in embodiments comprise one or more bands, having band widths as known for lasers

The term “light source” may (thus) refer to a light generating element as such, like e.g. a solid state light source, or e.g. to a package of the light generating element, such as a solid state light source, and one or more of a luminescent material comprising element and (other) optics, like a lens, a collimator. A light converter element (“converter element” or “converter”) may comprise a luminescent material comprising element. For instance, a solid state light source as such, like a blue LED, is a light source. A combination of a solid state light source (as light generating element) and a light converter element, such as a blue LED and a light converter element, optically coupled to the solid state light source, may also be a light source (but may also be indicated as light generating device). Hence, a white LED is a light source (but may e.g. also be indicated as (white) light generating device).

The term “light source” herein may also refer to a light source comprising a solid state light source, such as an LED or a laser diode or a superluminescent diode.

The “term light source” may (thus) in embodiments also refer to a light source that is (also) based on conversion of light, such as a light source in combination with a luminescent converter material. Hence, the term “light source” may also refer to a combination of a LED with a luminescent material configured to convert at least part of the LED radiation, or to a combination of a (diode) laser with a luminescent material configured to convert at least part of the (diode) laser radiation.

In embodiments, the term “light source” may also refer to a combination of a light source, like a LED, and an optical filter, which may change the spectral power distribution of the light generated by the light source. Especially, the “term light generating device” may be used to address a light source and further (optical components), like an optical filter and/or a beam shaping element, etc.

The phrases “different light sources” or “a plurality of different light sources”, and similar phrases, may in embodiments refer to a plurality of solid-state light sources selected from at least two different bins. Likewise, the phrases “identical light sources” or “a plurality of same light sources”, and similar phrases, may in embodiments refer to a plurality of solid-state light sources selected from the same bin.

Especially, the light generating devices comprise one or more of light emitting diodes (LED), diode lasers, and superluminescent diodes. Hence, in embodiments, one or more light generating devices comprise solid state light sources. Further, especially, the light generating devices are configured to generate visible light.

Instead of the term “lightguide” or “lightguide body” also the term “waveguide” may be applied.

In embodiments the lightguide body arrangement may comprise multiple components from different materials making up the lightguide body and the support system. In particular embodiments, the lightguide body may be a monolithic body from a material transmissive for device light. In specific embodiments, this may preferably be a solid transparent material, i.e., especially a glass, mineral, polymeric material, or alternatives for such materials.

Hence, the lightguide body may comprise a light transmissive material, more especially may essentially consist of a light transmissive material. The light transmissive material may comprise one or more materials selected from the group consisting of a transmissive organic material, such as selected from the group consisting of PE (polyethylene), PP (polypropylene), PEN (polyethylene naphthalate), PC (polycarbonate), polyurethanes (PU), polymethylacrylate (PMA), polymethylmethacrylate (PMMA) (Plexiglas or Perspex), polymethacrylimide (PMI), polymethylmethacrylimide (PMMI), styrene acrylonitrile resin (SAN), cellulose acetate butyrate (CAB), silicone, polyvinylchloride (PVC), polyethylene terephthalate (PET), including in an embodiment (PETG) (glycol modified polyethylene terephthalate), PDMS (polydimethylsiloxane), and COC (cyclo olefin copolymer). Especially, the light transmissive material may comprise an aromatic polyester, or a copolymer thereof, such as e.g. one or more of polycarbonate (PC), poly (methyl) methacrylate (P(M)MA), polyglycolide or polyglycolic acid (PGA), polylactic acid (PLA), polycaprolactone (PCL), polyethylene adipate (PEA), polyhydroxy alkanoate (PHA), polyhydroxy butyrate (PHB), poly(3-hydroxybutyrate-co-3-hydroxyvalerate) (PHBV), polyethylene terephthalate (PET), polybutylene terephthalate (PBT), polytrimethylene terephthalate (PTT), polyethylene naphthalate (PEN). Especially, the light transmissive material may comprise polyethylene terephthalate (PET). Hence, the light transmissive material is especially a polymeric light transmissive material. However, in another embodiment the light transmissive material may comprise an inorganic material. Especially, the inorganic light transmissive material may be selected from the group consisting of glasses, (fused) quartz, transmissive ceramic materials, and silicones. Also hybrid materials, comprising both inorganic and organic parts may be applied. Especially, the light transmissive material comprises one or more of PMMA, transparent PC, or glass, more especially PMMA or PC.

The surface of the lightguide body may be smooth in embodiments. In specific embodiments, light outcoupling elements (or light outcoupling structures) may be configured to facilitate outcoupling of the device light via the second face of the lightguide body and/or the second end of the lightguide body. The outcoupling elements may be comprise by the light transmissive material of the lightguide body and/or may be configured at the first face and/or second face. Especially, light outcoupling elements may be comprised by the light transmissive material of the lightguide body and/or may be configured at the second face.

Hence, the lightguide body, or waveguide, may comprise light outcoupling elements. This may include one or more of elements embedded by the light transmissive material, and elements at a face of the waveguide (such as at one or more of the first face and the second face, see also below).

The light outcouple elements may comprise particles embedded in the light transmissive material of the waveguide. Such particles may be (volume) scattering particles (like e.g. comprising one or more of Al₂O₃, BaSO₄ and TiO₂). The light outcouple elements may comprise elements at one or more faces of the waveguide, like indentations, scratches, grooves, dots of material, light scattering structures (in optical contact with one of the faces), etc, etc. Light outcouple elements are for instance described in WO9922268, WO2012059866, WO2018041470, and WO03027569, which are herein incorporated by reference. The light outcouple elements may be configured as regular pattern of light outcouple elements. The light outcouple elements may especially be configured to couple the device light out from the waveguide, such that an intensity of the device light may escape from the waveguide relatively evenly distributed over the waveguide.

In embodiments, the lightguide body may have a substantially rectangular planar shape, like a plate (except for the support structure). In embodiments, the lightguide body may have a tapering shape, tapering from a first and to a second end, with the first face and second face tapering. These faces may essentially be planar (except for the support structure). Hence, the light guide body may essentially have the shape of a (tapering) plate having a decreasing width over at least part of length or width.

In specific embodiments, the lightguide body may contain rounded shapes. For instance, the first face and/or the second face may be curved. In embodiments, a radius of the curvature may be substantially larger than a height of the lightguide body. Further, in embodiments the second end may be rounded (see also below).

The lightguide body may comprise a first face and a second face which define a width (W) selected from the range of 0.1-20 mm.

In particular, the first face may in specific embodiments be facing a reflector element. In such embodiments, the second face may be configured further away from the reflector element than the first face. Especially, the second face may be configured to allow outcoupling of device light.

In further embodiments, the lightguide body essentially comprises a first end and a second end of the lightguide body which define a height (H) of the lightguide body, which may especially be selected from the range of 10-1000 mm. In particular, the first end is configured nearest to and in a light-receiving relationship with one or more light generating devices, allowing device light entering the lightguide body via the first end, and to be transmitted through the lightguide body.

In specific embodiments, the first end may comprise a first end face. The light generating devices may be configured to irradiate this first end face with the device light. In specific embodiments, the device light may have a beam angle defined by the full width half maximum, in a plane parallel to the width (W) and height (H) of the lightguide body, selected from the range of 10-120°, like selected from the range of 25-100°. This may provide a good incoupling into the lightguide body and total internal reflection in the lightguide body. Hence, the “first end face” may also be indicated as light incoupling face. Essentially all device light that enters the lightguide body may enter via the first end face.

The second end may be configured furthest from the light generating devices and may in specific embodiments have an expanded end part element, providing additional support to the lightguide body. The expanded end part element may comprise a first tapering part, tapering in a direction from the second one to the first end, and a second tapering part, tapering in a direction from the first end to the second end. The first tapering part may be configured between the first range and the second tapering part. Hence, the expanded end part may facilitate escape of device light from the second end. The expanded end part may further help fixate the lightguide body without leading to sagging due to thermal or aging effects.

Hence in embodiments the second end may comprise a shape similar to a cross-section of a droplet.

In specific embodiments, the lightguide body may taper over at least part of the height (H) of the lightguide body in a direction from the first end to the second end within a first range defined by a first distance d1 from the first end and a second distance d2 from the first end. The first distance and second distance may be defined as 0.05≤|(d1−d2)/H|<1 relative to the height (H) of the lightguide body, more preferably for example the first distance and second distance may be defined as 2≤|(d1−d2)/H|<1 relative to the height (H) of the lightguide body.

In specific embodiments, the tapering angle may be selected from the range of 0.5-5°. As a consequence of this tapering, the width (W) of the lightguide body may change over the height (H) of the lightguide body. This may affect the spread of device light throughout the lightguide body, which may in specific embodiments need to be accounted for in the design of the final light generating system.

In embodiments, the lightguide body may taper over essentially its entire height, and especially over at least about 80% of its height. Note however, that herein also lightguide bodies are included that do not taper. A tapering may facilitate light outcoupling, like also light outcoupling elements may do.

Hence, in embodiments the lightguide body may be tapered to facilitate the outcoupling of device light at specific angles as may be selected for specific lighting devices. The tapering may also further help to fixate the lightguide body in position.

In yet further embodiments, the lightguide body may have a length (L) selected from the range of 10-3000 mm. However, other lengths may also be possible; the length may depend upon the desired application. In embodiments, the lightguide body may be defined by its length (L), height (H), and width (W), wherein L>H and H>W. In further embodiments, the lightguide body dimensions may be defined as H≥2*W and L≥2*H.

The lightguide body may comprise a support structure. The support structure may protrude relative to the first face or may be recessed relative to the first face. In specific embodiments, both types may be available. In general, however, either the support structure may protrude relative to the first face or may be recessed relative to the first face. The support structure may allow, together with the support system, fixating the light guide body in one or more directions.

In embodiments, the lightguide body and the associated support structure may be provided by removing sections from light transmissive material to provide the lightguide body (e.g. by cutting it out, such as by laser cutting, water cutting or milling, or by punching, such as using a special made tool or by a general cutting machine, or by spark erosion, etc.). The lightguide body (including the support structure) may also be provided via extrusion, extrusion molding, 3D printing, etc. A combination of two or more methods may also be applied.

In embodiments, the support structure may be located at a distance d5 along the height (H) from the first face of the lightguide body, wherein 0≤(d5/H)≤0.3 applies. Especially, 0<(d5/H)≤0.05 may be preferable, to have a minimal effect on the light distribution of device light in the lightguide body.

In specific embodiments, the support structure has a support structure length (L1) relative to the length (L) of the lightguide body, wherein 0.95*L≤L1≤L applies. In other embodiments (at least) L1≥0.5*L may apply.

In specific embodiments, the support structure and the first support element may be configured to fixate the lightguide body relative to the support system in a direction parallel to the height (H), allowing light to be transmitted from the first end to be outcoupled through the second face and the second end. This configuration may in embodiments be accomplished by having the support structure either recessed or protruded relative to the first face. In embodiments, where the support structure is recessed relative to the first face, the support structure and the first support element of the device support may be configured in a tongue-groove configuration. Hence, such embodiments may facilitate a robust fixation of the lightguide body that may be easily assembled, handled, and adjusted.

In further embodiments, the support structure may be protruded relative to the first face, wherein an arrangement of the first support element of the first support element, the device support part, and the support structure may be configured in a tongue-groove-configuration. Hence, such embodiments may facilitate a relatively efficient way of providing the support structure in the lightguide body, which may result in lower costs of production.

The support system may comprise a variety of different parts from different materials, including in specific embodiments a housing, a bezel, a spring, a screw, support elements, etc. These components may themselves comprise multiple distinct components of different materials. In embodiments, the housing may comprise solid materials that support and protect the lightguide body, e.g., metal, hard plastic, or wood materials, or a combination thereof. The housing may further comprise decorative elements in specific embodiments. In further embodiments, a bezel or a screw may comprise solid materials to provide a force on the lightguide body as part of its fixation and support, e.g., metal, or hard plastic materials, or a combination thereof. In further embodiments, a spring may comprise solid yet flexible materials to provide a force on the lightguide body as part of its fixation and support, e.g., metal, or plastic materials, or a combination thereof. The support elements may comprise solid yet flexible materials to support the lightguide body in a flexible manner, e.g., silicone, rubber, soft plastic materials, or a combination thereof. In embodiments, the support system may comprise the device support part and a lightguide body support part. The device support part is configured to support one or more light generating devices and may in specific embodiments be part of the housing or separate from the housing.

In embodiments, the lightguide body support part comprises one or more support elements up to a number of n2, which may be configured at a number of n2 arrangement support positions relative to the lightguide body, wherein n2≥3. One such arrangement support position may be configured at a third distance d3 from the first end at a distance 0<(d3/H)≤0.3 relative to the height (H) of the lightguide body. Another such arrangement support position may be configured most remote from the first end at a fourth distance d4 from the first end, at a distance 0.7≤(d4/H)<1.0 relative to the height (H) of the lightguide body. The other arrangement support position, most remote from the first end, may be configured in physical contact with the lightguide body arrangement. This arrangement of support elements may provide an even and flexible level of support to the lightguide body.

Hence, the support elements support the lightguide body and may allow it to be inserted and fixated in the lightguide body arrangement, providing support positions where the lightguide body may be in physical contact with one or more to ensure flexibility of the lightguide body arrangement. An additional benefit of the support elements may be that contact with the lightguide body is more defined and the resistance against bending is higher compared to a flat plane or a monolithic body as support elements. Further, they provide a shifting design to minimize the gap between the lightguide body and the housing. Yet further, they allow the absorption of thermal expansion of the lightguide body while ensuring a constant distance from the light generating devices to the lightguide body.

In further embodiments, the support elements may be in physical contact, but not in (substantial) optical contact with the lightguide body, which may be a risk when the support elements are composed of soft materials like silicones, rubbers, soft plastics, etc. Hence, this avoids in unwanted light outcoupling or unwanted light absorption.

In further embodiments, the other arrangement support position, most remote from the first end, is configured at the first tapering part of the expanded end part element. In yet further embodiments, the lightguide body touches the support element at this other arrangement support position, while the other support elements still allow a small gap to the reflector element or the first face of the lightguide body. Hence, in such embodiments, the support elements may provide additional support for expanded end part element which freely extends, allowing device light to escape through the second end of the lightguide body without leading to sagging, such as due to thermal or age effects, or other effects.

In embodiments, the first support element is configured in physical contact with the support structure at an arrangement support position at a distance d from the first end at 0≤(d/H)<1 relative to the height (H) of the lightguide body. In embodiments, the location of the first support element will be designed to be able to interlock with the support structure, the location of which is defined as 0≤(d5/H)<0.3 or especially 0≤(d5/H)<0.05 in embodiments. The first support element and the support structure are hence configured to fixate the lightguide body relative to the support system in a direction parallel to the height (H), allowing device light to be transmitted from the first end to escape through the second face and the second end.

In embodiments, the support structure is not in physical contact with the reflector element. Hence, in embodiments substantial the entire first face may be provided with a reflector (element), except for the support structure.

The support structure may have a height which is equal to or less than 50% of the height (H) of the lightguide body, such as at maximum 25%, like in embodiments 15% or less, like selected from the range of 2-15% of the height (H) of the lightguide body.

Hence, the configuration of the first support element to the support structure while in embodiments not touching the reflector element, may be desirable to facilitate a robust fixation of the lightguide body within the lightguide body arrangement.

In further embodiments, the lightguide body arrangement may additionally comprise further parts. In specific embodiments, this may especially comprise a reflector element from reflective materials such as metal materials or Teflon like material or an oxide coating, like MgO, TiO₂, or a BaSO₄ coating, or a layered combination of metals and dielectric materials, like Al, Ag, or SiO₂.

The reflector element may be configured to redirect at least part of the device light escaping from the lightguide body via the first face back into the lightguide body, where it is transmitted through the lightguide body and allowed to outcouple via the second face or the second end. To facilitate this, in embodiments the reflector element is placed in facing and following the contour of the first face of the lightguide body. In specific embodiments, the reflector element may be in physical contact with the first face of the lightguide body. Hence, in specific embodiments the reflector element may have a shape similar to the shape of the first face. For instance, the reflector element may have a shape supplementary to at least part of the first face, including at least part of the second tapering part (see also below).

Hence, the reflector element may allow the light generating system to redirect device light that would otherwise escape into the housing through the first face and instead adds to the device light that escaped the lightguide body through the second face and second end. This may facilitate more efficient generation of system light, and hence may result in decreased energy cost or increased light output.

In further embodiments, the support system may comprise a second arrangement configured to exert a force on the lightguide body in a direction of the lightguide body support part. In this second arrangement, the first support element and the support structure are configured to exert a force on the lightguide body in a direction of the device support part wherein the support system is configured to fixate the lightguide body relative to the support system in at least one direction parallel to the height (H).

In specific embodiments, the support system may be configured to fixate the lightguide body relative to the support system in more than one and up to three directions, in which case those directions will be orthogonal. In further such embodiments, the first support element may comprise a chamfer shape.

Hence, by providing one or more directional forces the lightguide body may be more firmly fixated within the lightguide body arrangement. This may facilitate minimizing the gap of a single lightguide body. This may additionally ensure thermal contact of the printed circuit board by adding a small continuous force from the lightguide towards the light generating device, which may improve the cooling of the printed circuit board. Further, such embodiments may facilitate management of the thermal expansion of the lightguide body. Yet further, these features are positioned outside of the visible area to optimize a homogenous look and feel of this lightguide body. The chamfer shape supports the ease of assembling, handling, and adjusting the lightguide body within the lightguide body arrangement.

In embodiments, part of one or more of the support structure and the support system may comprise a chamfer shape.

In other embodiments, the second arrangement may comprises a bezel element and/or a force element.

The bezel element may be configured in physical contact with part of the second face and in physical contact with or comprised by the device support part.

The force element (such as a screw, spring, etc.) may be configured to exert the force on the lightguide body in a direction of the lightguide body support part.

Further, the bezel element may function as a means to cover a section of the lightguide body arrangement. This may facilitate hiding bright spots caused by light leakage between the light generating devices and the lightguide body, and covering a section of the lightguide body closest to the first end where the device light beams generated by the light generating devices have not mixed yet.

In embodiments, at least part of the bezel element directed to the second face may be reflective for the device light.

In specific embodiments, the second arrangement comprises both the bezel element and the force element. In such embodiments, the force element (such as a screw, spring, etc.) may be configured to exert the force on the lightguide body in a direction of the lightguide body support part via the bezel element, though other embodiments may also be possible.

In further embodiments, the contact surface between the bezel element and the lightguide body may be minimized to prevent optical losses. In such embodiments, the contact surface may not have a sharp edge that will touch the light guide, preferably a radius (R) is applied defined as 5 mm<R<25 mm.

Hence, in such embodiments the lightguide body may be firmly fixated in the lightguide body arrangement using (the bezel element and) the force element. This may facilitate minimizing the gap of a single lightguide body. This may additionally ensure thermal contact of the printed circuit board by adding a small continuous force from the lightguide towards the light generating device which may improve the cooling of the printed circuit board. Further, such embodiments may facilitate management of the thermal expansion of the lightguide body. Yet further, these features may be positioned substantially outside of the visible area to optimize a homogenous look and feel of this lightguide body.

The bezel element may have a length essentially the same as the length of the lightguide body, such as 0.9*L-1.05*L, more especially 0.9*L-L.

The force element may locally provide the force to the lightguide body. For instance, in embodiments the force element may have physical contact with the lightguide body with less than about 2% of a surface area of the second face (whether or not the force is exerted via the bezel element). Hence, also the optional bezel element may (thus) in embodiments have physical contact with the lightguide body with less than about 2% of a surface area of the second face (whether or not the force element is used).

In further embodiments, the light generating system may comprise a number of n1 light generating devices having a pitch (P). In embodiments, the pitch may e.g. be selected from the range of 0.5-50 mm, such as 1-20 mm. However, also other values may be possible.

In specific embodiments, the bezel element may have a bezel height that is defined as 0.5≤P/H1≤1.25 relative to the pitch (P) of the light generating devices. Especially, the bezel height may be defined as 0.75≤P/H1≤1. Such heights of the bezel element appear to be useful as the bezel function may be available whereas blocking of light may be minimal.

In embodiments, the light generating devices may be functionally coupled to the light generating device support and extend from the light generating support to have a device height (H2) relative to the light generating device support. The light generating system may comprise distance elements, configured between the light generating device support and the lightguide body and configured to have a distance element height (H3) relative to the light generating device support, wherein H3>H2. In embodiments 1.05*H2≤H3≤5*H2, such as 1.1*H2≤H3≤2.5*H2. The light generating device support may be comprised by the device support or may be configured between the device support part and the lightguide body. In further embodiments, the distance elements may be configured to number an average of 1 distance element every 8-12 cm along the length (L) of the lightguide body. Especially, the distance elements may be configured to number an average of 1 distance element every 10 cm along the length (L) of the lightguide body. The number of distance elements may be smaller than the number of light generating devices, though especially the number of distance elements may in embodiments be at least three.

Hence, in such embodiments, the distance elements may ensure that the lightguide body may be fixated within the lightguide body arrangement without risk of damaging the light generating devices while simultaneously facilitating proximity of the light generating devices to the first end or first end face to irradiate the lightguide body.

In embodiments, the light generating system may be configured to generate system light comprising device light escaped from the lightguide body via the second face and the second end. Especially, the system light may in embodiments comprises white light, more especially be white light.

The term “white light”, and similar terms, herein, is known to the person skilled in the art. It may especially relate to light having a correlated color temperature (CCT) between about 1800 K and 20000 K, such as between 2000 and 20000 K, especially 2700-20000 K, for general lighting especially in the range of about 2000-7000 K, such as in the range of 2700 K and 6500 K. In embodiments, e.g. for backlighting purposes, or for other purposes, the correlated color temperature (CCT) may especially be in the range of about 7000 K and 20000 K. Yet further, in embodiments the correlated color temperature (CCT) is especially within about 15 SDCM (standard deviation of color matching) from the BBL (black body locus), especially within about 10 SDCM from the BBL, even more especially within about 5 SDCM from the BBL.

In specific embodiments, the correlated color temperature (CCT) may be selected from the range of 6000-12000 K, like selected from the range of 7000-12000 K, like at least 8000 K. Yet further, in embodiments the correlated color temperature (CCT) may be selected from the range of 1000-12000 K, like selected from the range of 1800-8000 K, in combination with a CRI of at least 80.

In further embodiments, the system light may comprise visible light, such as violet light, blue light, green light, yellow light, orange light, red light, pink light, cyan light, amber light, or light having one more wavelengths in a wavelength range. The terms “visible”, “visible light” or “visible emission” and similar terms refer to light having one or more wavelengths in the range of about 380-780 nm. The terms “violet light” or “violet emission” especially relates to light having a wavelength in the range of about 380-440 nm. The terms “blue light” or “blue emission” especially relates to light having a wavelength in the range of about 440-495 nm (including some violet and cyan hues). The terms “green light” or “green emission” especially relate to light having a wavelength in the range of about 495-570 nm. The terms “yellow light” or “yellow emission” especially relate to light having a wavelength in the range of about 570-590 nm. The terms “orange light” or “orange emission” especially relate to light having a wavelength in the range of about 590-620 nm. The terms “red light” or “red emission” especially relate to light having a wavelength in the range of about 620-780 nm. The term “pink light” or “pink emission” refers to light having a blue and a red component. The term “cyan” may refer to one or more wavelengths selected from the range of about 490-520 nm. The term “amber” may refer to one or more wavelengths selected from the range of about 585-605 nm, such as about 590-600 nm. The phrase “light having one or more wavelengths in a wavelength range” and similar phrases may especially indicate that the indicated light (or radiation) has a spectral power distribution with at least intensity or intensities at these one or more wavelengths in the indicate wavelength range. For instance, a blue emitting solid state light source will have a spectral power distribution with intensities at one or more wavelengths in the 440-495 nm wavelength range. Hence, such embodiments may use the light generating system in a broad range of lighting devices or as a method to facilitate the assembly of such embodiments.

As the light generating system may comprise a plurality of light generating devices, it may also be possible in embodiment to control the spectral power distribution of the system light. Hence, in specific embodiments two or more of the plurality of light generating devices may be configured to generate device light having different spectral power distribution, in more specific embodiments different color points.

In specific embodiments, colors or color points of a first type of light and a second type of light may be different when the respective color points of the first type of light and the second type of light differ with at least 0.01 for u′ and/or with at least 0.01 for v′, even more especially at least 0.02 for u′ and/or with at least 0.02 for v′. In yet more specific embodiments, the respective color points of first type of light and the second type of light may differ with at least 0.03 for u′ and/or with at least 0.03 for v′. Here, u′ and v′ are color coordinate of the light in the CIE 1976 UCS (uniform chromaticity scale) diagram.

In specific embodiments, two or more of the plurality of light generating devices may be configured to generate device light having different colors.

Therefore, in specific embodiments the light generating system may further comprise a control system or be functionally coupled to a control system. The control system may be configured to control the spectral properties of the system light.

The light generating system may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, (outdoor) road lighting systems, urban lighting systems, green house lighting systems, horticulture lighting, digital projection, or LCD backlighting. The light generating system (or luminaire) may be part of or may be applied in e.g. optical communication systems or disinfection systems.

In an aspect, the invention also provides a method for assembling the light generating system as described herein. In embodiments, the method may comprise the assembly of (i) one or more light generating devices configured to generate device light, (ii) a lightguide body arrangement comprising a lightguide body, and (iii) a support system, into the light generating system. Hence, by this method of assembly the lightguide body may be fixated relative to the support system in a direction parallel to the height (H) of the lightguide body.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc., Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions from a remote control. In embodiments, the control system may be controlled via an App on a device, such as a portable device, like a Smartphone or I-phone, a tablet, etc., The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, WIFI, LiFi, ZigBee, BLE or WiMAX, or another wireless technology.

The system, or apparatus, or device may execute an action in a “mode” or “operation mode” or “mode of operation” or “operational mode”. The term “operational mode may also be indicated as “controlling mode”. Likewise, in a method an action or stage, or step may be executed in a “mode” or “operation mode” or “mode of operation” or “operational mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

In yet a further aspect, the invention also provides a lamp or a luminaire comprising the light generating system as defined herein. The luminaire may further comprise a housing, optical elements, louvres, etc, etc., The lamp or luminaire may further comprise a housing enclosing the light generating system. The lamp or luminaire may comprise a light window in the housing or a housing opening, through which the system light may escape from the housing. In yet a further aspect, the invention also provides a projection device comprising the light generating system as defined herein. Especially, a projection device or “projector” or “image projector” may be an optical device that projects an image (or moving images) onto a surface, such as e.g. a projection screen. The projection device may include one or more light generating systems such as described herein. Hence, in an aspect the invention also provides a light generating device selected from the group of a lamp, a luminaire, a projector device, a disinfection device, a photochemical reactor, and an optical wireless communication device, comprising the light generating system as defined herein. The light generating device may comprise a housing or a carrier, configured to house or support, one or more elements of the light generating system. For instance, in embodiments the light generating device may comprise a housing or a carrier, configured to house or support one or more of a lamp, a luminaire, a projector device, a disinfection device, a photochemical reactor, and an optical wireless communication device, comprising one or more light generating systems.

In a further aspect according to the invention, the invention provides an improved lightguide body. Thereto, the invention provides: a lightguide body, wherein the lightguide body comprises (a) a first face and a second face, which define a width (W) of the lightguide body, (b) a first end and a second end, which define a height (H) of the lightguide body, wherein the first end is configured in a light-receiving relationship with the one or more light generating devices; and wherein the lightguide body is transmissive for the device light; wherein the lightguide body tapers over at least part of the height (H) in a direction from the first end to the second end within a first range defined by a first distance d1 from the first end and a second distance d2 from the first end (261), wherein 0.05≤|(d1−d2)/H|<1, preferably 0.2≤|(d1−d2)/H|<1; wherein the lightguide body comprises an expanded end part element, wherein the expanded end part element comprises (a) a first tapering part, tapering in a direction from the second end to the first end, and (b) a second tapering part, tapering in a direction from the first end to the second end; wherein the first tapering part is configured between the first range and the second tapering part. Thereby, advantages and/or embodiments applying to the lightguide body arrangement AND/OR the light generating system according to the initial aspect of the invention may mutatis mutandis apply to this further aspect according to the invention.

The advantage of said lightguide body according to the further aspect of the invention is that the expanded end part element reduces glare, which originates from the fact that the optical performance of the lightguide body is improved (i.e. allowing light to be transmitted through optimally with for example an support system that has minimal influence thereto).

In an embodiment, (a) the lightguide body tapers over at least part of the height (H) in the direction from the first end to the second end with a tapering angle (a) selected from the range of 0.5-5°, and (b) the lightguide body comprises outcoupling elements configured to facilitate outcoupling of the device light via the second face.

In an embodiment, the lightguide body comprises a length (L); wherein L>H>W; wherein the height (H) is selected from the range of 10-1000 mm, the width (W) is selected from the range of 0.1-20 mm, and the length (L) is selected from the range of 10-3000 mm, wherein H≥2*W and L≥2*H.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1A-D schematically depict embodiments of the system;

FIG. 2A-C schematically depict further embodiments of the system;

FIG. 3 schematically depicts yet further embodiments of the system;

FIG. 4A-B schematically depicts embodiments of the light generating device.

The schematic drawings are not necessarily to scale.

### DETAILED DESCRIPTION OF THE EMBODIMENTS

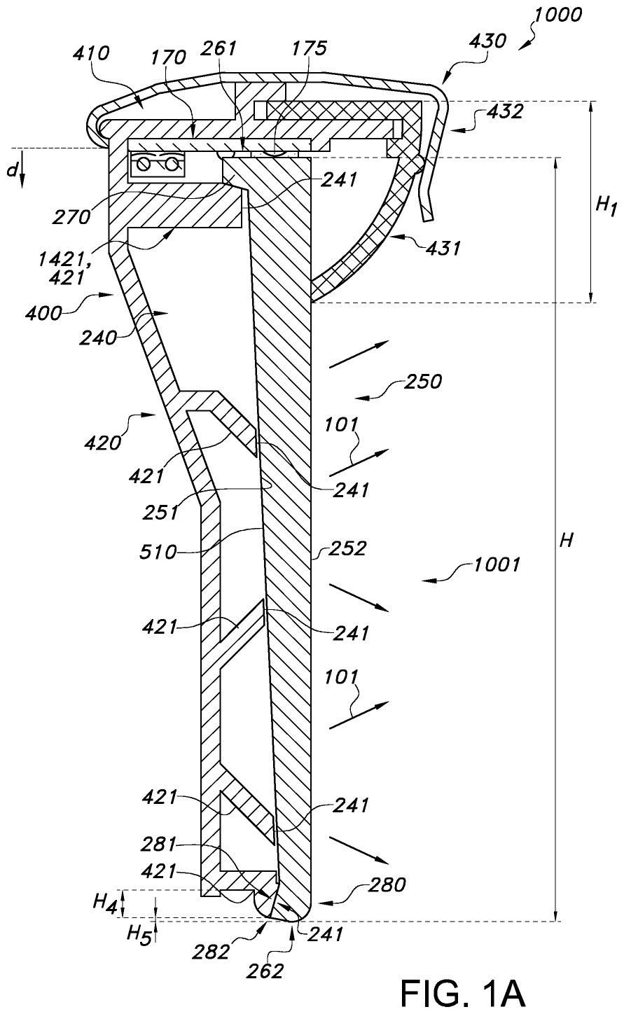

FIG. 1A-D schematically depicts a system 1000 comprising (i) a one or more light generating devices 100 configured to generate device light 101, (ii) a lightguide body arrangement 240 comprising a lightguide body 250, and (iii) a support system 400. The lightguide body 250 comprises (a) a first face 251 and a second face 252, which define a width W of the lightguide body 250, and (b) a first end 261 and a second end 262, which define a height H of the lightguide body 250. The lightguide body 250 comprises a support structure 270 protruded or recessed relative to the first face 251, wherein the first end 261 is configured in a light-receiving relationship with the one or more light generating devices 100, and the lightguide body 250 is transmissive for the device light 101. The support system 400 comprises (a) a device support part 410 and (b) a lightguide body support part 420. The device support part 410 is configured to support the one or more light generating devices 100. The lightguide body support part 420 comprises one or more support elements 421. A first support element 1421 of the one or more support elements 421 is configured in physical contact with the support structure 270 at an arrangement support position 241 at a distance d from the first end 261, wherein 0≤(d/H)<1. The first support element 1421 and the support structure 270 are configured to fixate the lightguide body 250 relative to the support system 400 in a direction parallel to the height H.

In embodiments, the lightguide body arrangement 240 comprises the lightguide body 250 and a reflector element 510 configured to reflect at least part of the device light 101 escaping from the lightguide body 250 via the first face 251 back into the lightguide body 250. The light generating system 1000 is configured to generate system light 1001, wherein the system light 1001 comprises device light 101 escaped from the lightguide body 250 via the second face 252 and the second end 262.

In embodiments, the support system 400 comprises a second arrangement 430 configured to exert a force on the lightguide body 250 in a direction of the lightguide body support part 420. The first support element 1421 and the support structure 270 are configured to exert a force on the lightguide body 250 in a direction of the device support part 410. The support system 400 is configured to fixate the lightguide body 250 relative to the support system 400 in at least one direction, of which one is parallel to the height H. The first support element 1421 comprises a chamfer shape. The one or more light generating devices 100 comprise solid state light sources.

FIG. 1A schematically depicts a specific embodiment where the second arrangement 430 comprises a bezel element 431 and a force element 432. The bezel element 431 is configured in physical contact with part of the second face 252 and is in physical contact with or is comprised by the device support part 410. The force element 432 is configured to exert the force on the lightguide body 250 in a direction of the lightguide body support part 410 via the bezel element 431. The light generating system 1000 comprises light generating devices 100 having a pitch P, and the bezel element 431 has a bezel height H1, wherein 0.75≤P/H1≤1.25.

In embodiments, the support structure 270 is protruded relative to the first face 251. An arrangement of the first support element 1421, the device support part 410, and the support structure 270 are configured in a tongue-groove configuration.

In embodiments, the lightguide body 250 comprises a length L and the support structure 270 has a support structure length L1, wherein 0.95*L≤L1≤SL applies.

In embodiments, the light generating system 1000 comprises a light generating device support 170. One or more light generating devices 100 are functionally coupled to the light generating device support 170, extend from the light generating device support 170 and have a device height H2 relative to the light generating device support 170. The light generating system 1000 further comprises one or more distance elements 175, configured between the light generating device support 170 and the lightguide body 250, where one or more distance elements 175 have a distance element height H3 relative to the light generating device support 170, wherein H3>H2. The light generating device support 170 is comprised by the device support part 410 or is configured between the device support part 410 and the lightguide body 250.

In embodiments, the lightguide body 250 tapers over at least part of the height H in a direction from the first end 261 to the second end 262 within a first range defined by a first distance from the first end 261 and a second distance from the first end 261.

In embodiments, the lightguide body 250 comprises an expanded end part element 280 which comprises (a) a first tapering part 281, tapering in a direction from the second end 262 to the first end 261 along a first tapering part height H4, and (b) a second tapering part 282, tapering in a direction from the first end 261 to the second end 262 along a second tapering part height H5. The first tapering part 281 is configured between the first range and the second tapering part 282.

In alternatively phrased embodiments, the lightguide body 250 comprises an expanded end part element 280. The light guide body 250 comprises a first taper end point (not explicitly referred to in the figures) at the first face 251 and a second taper end point (not explicitly referred to in the figures) at the second face 252. Said first taper end point and said second taper end point demarcate the point (or line when considering the length (L) dimension of the lightguide body as well) at which said light guide body (250) stops tapering in the direction from the first end 261 to the second end 262. Furthermore, as mentioned, the lightguide body 250 comprises an expanded end part element 280, wherein the expanded end part element 280 comprises (a) a flat face 281 abutting the first face 251 at the first taper end point, wherein the flat face 281 is arranged at an angle between 20 and 50 degrees relative to the first face 251, and (b) an at least partly curved face abutting the second face 252 at the second taper end point and comprising a curvature; wherein the flat face 281 and the curved face connect to each other.

In embodiments, the light generating system 1000 comprises support elements 421 configured at arrangement support positions 241. One arrangement support position 241 is configured at a third distance from the first end 261. Another arrangement support position 241, most remote from the first end 261, is configured at a fourth distance from the first end 261, and is configured in physical contact with the lightguide body arrangement 240.

FIG. 1A-D schematically depict a specific embodiment where the other arrangement support position 241, most remote from the first end 261, is configured at the first tapering part 281 of the expanded end part element 280.

In embodiments, the lightguide body 250 tapers over at least part of the height H in the direction from the first end 261 to the second end 262 with a tapering angle α selected from the range of 0.5-5°. A first tapering angle α comprises the tapering angle of the second face of the lightguide body relative to the vertical plane V that comprises the midway plane between the first face and the second face of the lightguide body. A second tapering angle α₂ comprises the tapering angle of the first face of the lightguide body relative to the vertical plane V.

In embodiments, the first end 261 comprises a first end face 253. One or more light generating devices 100 are configured to irradiate with the device light 101 the first end face 253. The device light 101 has a beam angle, defined by the full width half maximum, in a plane parallel to the width W and the height H of the lightguide body 250, selected from the range of 10-120°. The lightguide body 250 comprises a length L; wherein L>H>W. The height H is selected from the range of 10-1000 mm, the width W is selected from the range of 0.1-20 mm, and the length L is selected from the range of 10-3000 mm, wherein H≥2*W and L≥2*H.

In embodiments, the light generating system 1000 is configured to generate system light 1001 comprising device light 101 escaped from the lightguide body 250 via the second face 252 and the second end 262. The system light 1001 has a correlated color temperature selected from the range of 1800-8000 K and a color rendering index selected from the range of at least 80.

The embodiments of light generating systems may be assembled from (i) a one or more light generating devices 100 configured to generate device light 101, (ii) a lightguide body arrangement 240 comprising a lightguide body 250, and (iii) a support system 400, into the light generating system 1000 thereby fixating the lightguide body 250 relative to the support system 400 in a direction parallel to the height H of the lightguide body 250.

FIG. 1A also schematically depicts an embodiment where the system 1000 comprises a reflector element 510. The first end 261 is configured in a light-receiving relationship with the one or more light generating devices 100, configured to irradiate with the device light 101 the first end face 253 (see FIGS. 1B etc.).

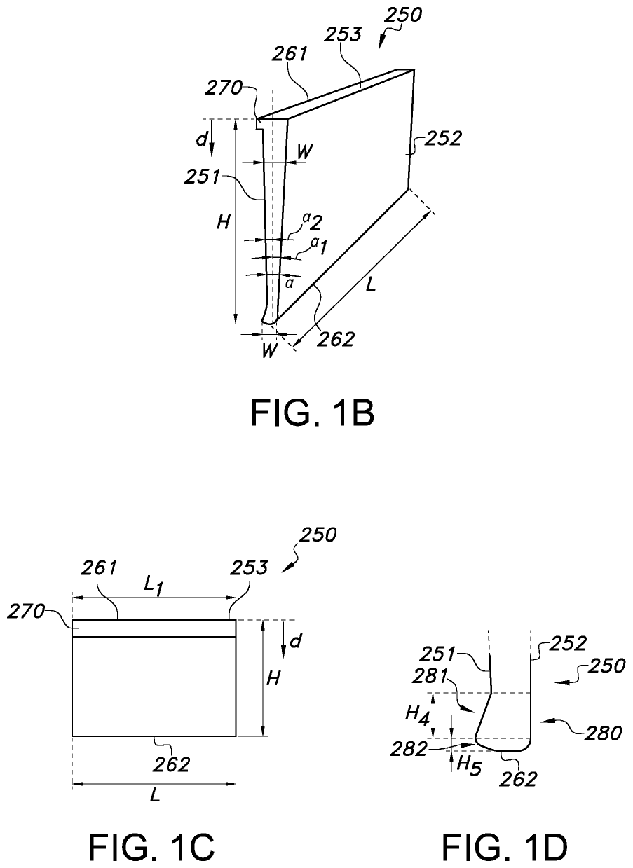

FIG. 2A-C schematically depict embodiments where the system 1000 comprises (a) a lightguide body arrangement 240 comprising a lightguide body 250 and (b) a support system 400. In such embodiments, the lightguide body 250 comprises a support structure 270 recessed relative to the first face 251. The lightguide body further comprises (i) a first end 261 and a second end 262, which define a height H of the lightguide body 250, and (ii) a first face 251 and a second face 252, which define a width W of the lightguide body 250. The first end 261 comprises a first end face 253. The support system 400 comprises one or more support elements 421. A first support element 1421 of the one or more support elements 421 is configured in physical contact with the support structure 270 at an arrangement support position 241 at a distance d from the first end 261. In these embodiments, the first support element 1421 and the support structure 270 are configured in a tongue-groove configuration.

FIG. 2A schematically depicts such embodiments where the system 1000 comprises (a) a one or more light generating devices 100, (b) a lightguide body arrangement 240 comprising a lightguide body 250 and a reflector element 510, (c) a support system 400, and (d) a light generating device support 170. The first end 261 is configured in a light-receiving relationship with the one or more light generating devices 100, configured to irradiate with the device light 101 the first end face 253.

FIG. 2B schematically depicts such embodiments where a lightguide body 250 comprises a length L and tapers over at least part of the height H in the direction from the first end 261 to the second end 262 with a tapering angle α selected from the range of 0.5-5°.

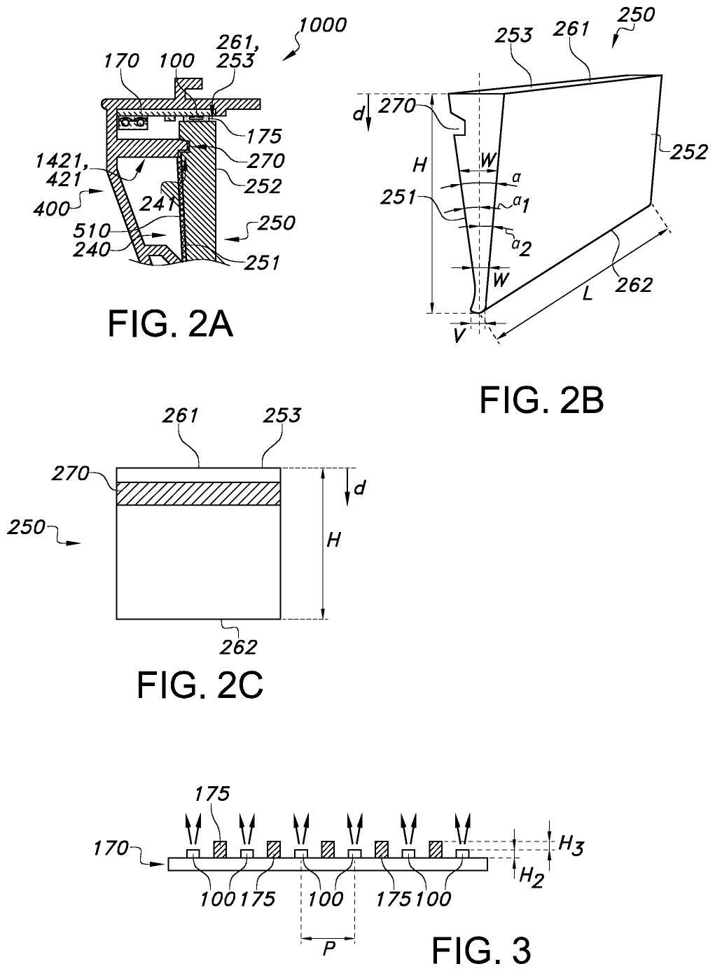

FIG. 3 schematically depicts embodiments where the light generating system 1000 comprises a light generating device support 170 and the light generating devices 100 have a pitch P. One or more light generating devices 100 are functionally coupled to the light generating device support 170, extend from the light generating device support 170 and have a device height H2 relative to the light generating device support 170. The light generating system 1000 further comprises one or more distance elements 175, configured between the light generating device support 170 and the lightguide body 250, where one or more distance elements 175 have a distance element height H3 relative to the light generating device support 170, wherein H3>H2. The light generating device support 170 is comprised by the device support part 410 or is configured between the device support part 410 and the lightguide body 250.

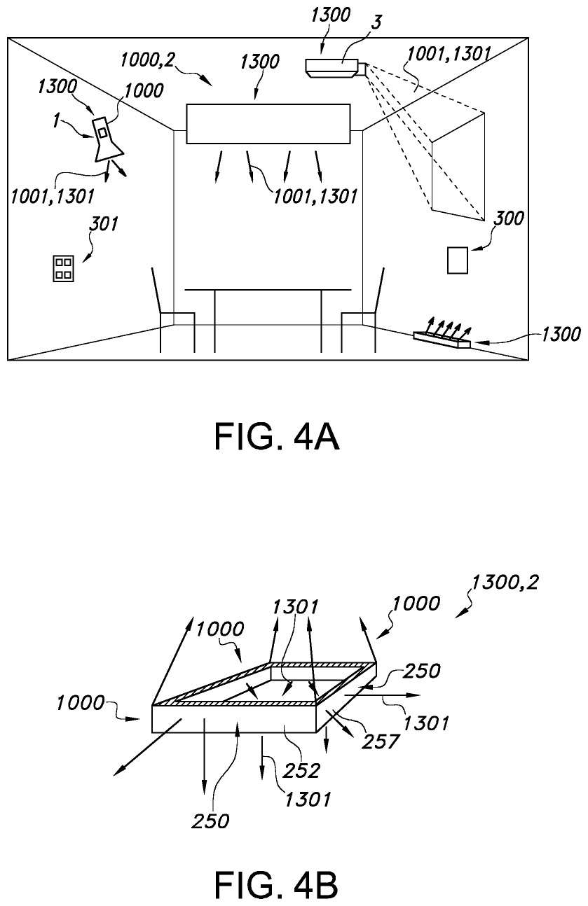

FIG. 4A-B schematically depicts an embodiment of a luminaire 2 comprising the light generating system 1000 as described above. Reference 301 indicates a user interface which may be functionally coupled with the control system 300 comprised by or functionally coupled to the light generating system 1000. FIG. 4A also schematically depicts an embodiment of lamp 1 comprising the light generating system 1000. Reference 3 indicates a projector device or projector system, which may be used to project images, such as at a wall, which may also comprise the light generating system 1000. Hence, FIG. 4A schematically depicts embodiments of a lighting device 1300 selected from the group of a lamp 1, a luminaire 2, a projector device 3, a disinfection device, a photochemical reactor, and an optical wireless communication device, comprising the light generating system 1000 as described herein. In embodiments, such lighting device may be a lamp 1, a luminaire 2, a projector device 3, a disinfection device, or an optical wireless communication device. Lighting device light escaping from the lighting device 1300 is indicated with reference 1301. Lighting device light 1301 may essentially consist of system light 1001, and may in specific embodiments thus be system light 1001. In specific embodiments of the lighting device 1300, the light generating system comprises a lightguide body 250 that comprises outcoupling elements 257 configured to facilitate outcoupling of lighting device light 1301 via the second face 252.

FIG. 4b shows a luminaire 2 or lighting device 1300, comprising four arrangements of (i) one or more light generating devices (not explicitly shown), (ii) a lightguide body arrangement comprising a lightguide body, and (iii) a support system (not explicitly shown.

Other embodiments than described above and schematically depicted in the accompanying drawings, but within the scope of the accompanying claims, may also be possible.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage. In yet a further aspect, the invention (thus) provides a software product, which, when running on a computer is capable of bringing about (one or more embodiments of) the method as described herein.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A light generating system comprising (i) a one or more light generating devices configured to generate device light, (ii) a lightguide body arrangement comprising a lightguide body, and (iii) a support system; wherein:
the lightguide body comprises (a) a first face and a second face, which define a width of the lightguide body, (b) a first end and a second end, which define a height of the lightguide body, wherein the lightguide body comprises a support structure protruding from the first face or recessed relative to the first face; wherein the first end is configured in a light-receiving relationship with the one or more light generating devices; and wherein the lightguide body is transmissive for the device light;
wherein the lightguide body tapers over a part of the height in a direction from the first end to the second end; wherein the light guide body comprises a first taper end point at the first face and a second taper end point at the second face, wherein said first taper end point and said second taper end point demarcate the point at which said light guide body stops tapering in the direction from the first end to the second end; wherein the lightguide body comprises an expanded end part element; and
the support system comprises (a) a device support part and (b) a lightguide body support part; wherein the device support part is configured to support the one or more light generating devices; wherein the lightguide body support part comprises one or more support elements; wherein a first support element of the one or more support elements is configured in physical contact with the support structure at an arrangement support position at a distance d from the first end, wherein 0≤(d/H)<1; and wherein the first support element and the support structure are configured to fixate the lightguide body relative to the support system in a direction parallel to the height (H).

2. The light generating system according to claim 1, wherein the expanded end part element comprises (a) a flat face abutting the first face at the first taper end point, wherein the flat face is arranged at an angle between 20 and 50 degrees relative to the first face, and (b) a curved face abutting the second face at the second taper end point and comprising a curvature; wherein the flat face and the curved face connect to each other.

3. The light generating system according to claim 1, wherein the lightguide body arrangement comprises the lightguide body and a reflector element, wherein the reflector element is configured to reflect at least part of the device light escaping from the lightguide body via the first face back into the lightguide body; wherein the light generating system is configured to generate system light, wherein the system light comprises device light escaped from the lightguide body via the second face and the second end.

4. The light generating system according to claim 1, wherein the support system comprises a second arrangement, wherein the second arrangement is configured to exert a force on the lightguide body in a direction of the lightguide body support part; wherein first support element and the support structure are configured to exert a force on the lightguide body in a direction of the device support part; wherein the support system is configured to fixate the lightguide body relative to the support system in at least one direction parallel to the height (H); and wherein the first support element comprises a chamfer shape; wherein the one or more light generating devices comprise solid state light sources.

5. The light generating system according to claim 4, wherein the second arrangement comprises a bezel element and a force element; wherein the bezel element is configured in physical contact with part of the second face; wherein the bezel element is in physical contact with or is comprised by the device support part; wherein the force element is configured to exert the force on the lightguide body in a direction of the lightguide body support part via the bezel element; wherein the light generating system comprises n1 light generating devices having a pitch; wherein the bezel element has a bezel height (H1), wherein 0.75≤P/H1≤1.25.

6. The light generating system according to claim 1, wherein the support structure is recessed relative to the first face; where the first support element and the support structure are configured in a tongue-groove configuration.

7. The light generating system according to claim 1, wherein the support structure is protruded relative to the first face; where (a) an arrangement of the first support element and the device support part, and (b) the support structure are configured in a tongue-groove configuration.

8. The light generating system according to claim 1, wherein the lightguide body comprises a length; wherein the support structure has a support structure length, wherein 0.95*L≤L1≤L applies.

9. The light generating system according to claim 1, comprising a light generating device support; wherein:
the one or more light generating devices are functionally coupled to the light generating device support; wherein the one or more light generating devices extend from the light generating device support and have a device height relative to the light generating device support;
the light generating system further comprises one or more distance elements, configured between the light generating device support and the lightguide body, wherein the one or more distance elements have a distance element height relative to the light generating device support, wherein H3>H2; and
the light generating device support is comprised by the device support part or is configured between the device support part and the lightguide body.

10. The light generating system according to claim 1, comprising n2 support elements configured at n2 arrangement support positions; wherein n2≥3; wherein one arrangement support position is configured at a third distance d3 from the first end, wherein 0<(d3/h)≤0.3; wherein another arrangement support position, most remote from the first end, is configured at a fourth distance d4 from the first end, wherein 0.75≤(d4/H)<1.0; and wherein the at the other arrangement support position, most remote from the first end, the support element is configured in physical contact with the lightguide body arrangement.

11. The light generating system according to claim 1, wherein one or more of the following applies: (a) the lightguide body tapers over at least part of the height in the direction from the first end to the second end with a tapering angle (α) selected from the range of 0.5-5°, and (b) the lightguide body comprises outcoupling elements configured to facilitate outcoupling of the device light via the second face.

12. The light generating system according to claim 1, wherein:
the first end comprises a first end face;
the one or more light generating devices are configured to irradiate with the device light the first end face;
the device light has a beam angle (θ), defined by the full width half maximum, in a plane parallel to the width and the height of the lightguide body, selected from the range of 10-120°; and
the lightguide body comprises a length; wherein L>H>W; wherein the height is selected from the range of 10-1000 mm, the width is selected from the range of 0.1-20 mm, and the length is selected from the range of 10-3000 mm, wherein H≥2*W and L≥2*H.

13. A method for assembling the light generating system according to claim 1, the method comprising:
assemble (i) a one or more light generating devices configured to generate device light, (ii) a lightguide body arrangement comprising a lightguide body, and (iii) a support system, into the light generating system thereby fixating the lightguide body relative to the support system in a direction parallel to the height of the lightguide body.
